(19) United States
(12) Patent Application Publication
(10) Pub. No.: US 2010/0138325 A1
(43) Pub. Date: Jun. 3, 2010

(54) METHODS AND ARRANGEMENTS INVOLVING ADAPTIVE AUDITING AND RATING FOR DISPARATE DATA PROCESSING

(76) Inventor: Dean W. Hahn-Carlson, Lilydale, MN (US)

Correspondence Address: CRAWFORD MAUNU PLLC, 1150 NORTHLAND DRIVE, SUITE 100, ST. PAUL, MN, 55120, US

(21) Appl. No.: 12/626,406

(22) Filed: Nov. 25, 2009

Related U.S. Application Data
(60) Provisional application No. 61/118,325, filed on Nov. 26, 2008.

(51) Int. Cl. G06Q 20/00; G06Q 40/00; G06Q 10/00

(52) U.S. Cl. 705/30; 705/40

(57) ABSTRACT

Electronic transactions are audited using a processing system to interact with each of a multitude of entity-specific processor circuits to process transaction data sets. In connection with an example embodiment, a processor circuit communicates with entity-specific processor circuits to receive electronic transaction data sets therefrom, each set of transaction data pertaining to an electronic account. The processor circuit executes processing functions to audit the transaction data set and generate evaluation information for use by the entity-specific processor, respectively using auditing rules defined for the entity-specific processor and evaluation criteria available to the processor circuit.

### RELATED PATENT DOCUMENTS

This patent document claims the benefit, under 35 U.S.C. §119(e), of U.S. Provisional Patent Application Ser. No. 61/118,325 filed on Nov. 26, 2008; this patent document is fully incorporated herein by reference.

### FIELD

The present invention is directed to adaptive auditing and rating systems and methods involving tiered architectures for disparate data processing.

### BACKGROUND

Computer-based systems and networks employed by disparate institutions operate relatively autonomously for processing data sets pertaining to different electronically-identified accounts. In many instances, operational management of contractual and transactional interactions has been labor/processor load and time intensive. In addition, the administration of disparately-controlled data sets such as used by autonomous computers controlled by different institutions, whether financial or otherwise, has been unduly burdensome and inefficient.

Various institutions employ processing, auditing and evaluation parameters that are unique to each institution and thus generally incompatible among systems operated at disparate institutions. In addition, these transaction processing parameters often need to be kept separate (and confidential), relative to other institutions. Often, transaction processing is dependent upon these parameters, which are specific to a particular institution to which data sets apply. In this regard, processing, auditing and evaluation functions have been limited to institution-specific processors. However, institution-specific processors have generally been further limited in their ability to access data and other tools for performing such processing, auditing and evaluation.

The above and other difficulties have presented challenges to entities and related institutional processors as discussed above.

### SUMMARY

The present invention is exemplified in a number of implementations and applications, some of which are summarized below.

According to an example embodiment, transaction data sets are audited and evaluated as follows. A plurality of entity-specific processor circuits, respectively operated on behalf of one of a plurality of disparate sponsoring entities, store data identifying each of a plurality of electronic accounts, and for received transaction data, generate a transaction data set indicative of the received transaction data and associated with the data identifying one of the electronic accounts. For each of the electronically-identified accounts, value data is generated and assigned to the account in response to received audit and evaluation result data for transaction data sets associated with the account. A service processor circuit is configured, for each transaction data set received from an entity-specific processor, to associate the transaction data set with the entity-specific processor and, based upon the association, to retrieve auditing rules defined for the entity-specific processor. The service processor circuit accesses and executes an auditing algorithm as a function of the retrieved auditing rules, using data in the transaction data set as an input to the algorithm, therein generating audit data for the transaction data set. The service processor circuit retrieves evaluation criteria based upon data in the transaction data set specifying at least one of an identity associated with the entity-specific processor circuit and data indicative of an electronic account to which the transaction data set applies. The retrieved evaluation criteria is used with data in the transaction data set to derive evaluation result data for the transaction data set, and the generated audit data and derived evaluation result data is provided for access by the entity-specific processor circuit that generated the transaction data set.

Other aspects of the invention are directed to a processor-readable storage medium, upon which data instructions are stored, where such instructions, when executed by a software-programmed computer processor (or processors), cause the processor to carry out steps according to various embodiments described above and/or otherwise herein.

The above summary is not intended to describe each illustrated embodiment or every implementation of the present invention.

### BRIEF DESCRIPTION OF THE DRAWINGS

The invention may be more completely understood in consideration of the detailed description of various embodiments of the invention in connection with the accompanying drawings, in which:

FIG. 1 shows a system for auditing and evaluation of data sets processed by a multitude of disparate entities and their respective processors, according to an example embodiment of the present invention; and

FIG. 2 shows a flow diagram for auditing and evaluation of data sets, according to another example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention, including that defined by the claims.

### DETAILED DESCRIPTION

The present invention is believed to be applicable to a variety of different types of processing systems/circuits and related integrated management and control, and has been found to be particularly useful for auditing and evaluating data sets on behalf of disparate entity processors, at a service processor having access to entity-specific auditing data and other evaluation data. While the present invention is not necessarily limited to such approaches, various aspects of the invention may be appreciated through a discussion of various examples using these and other contexts.

According to an example embodiment, a service processor circuit is configured, for each transaction data set received from an entity-specific processor, to associate the transaction data set with the entity-specific processor and to retrieve auditing rules defined for the entity-specific processor based upon the association. The service processor circuit accesses and executes an auditing algorithm as a function of the retrieved auditing rules, using data in the transaction data set as an input to the algorithm and therein generating audit data for the transaction data set. The service processor circuit also retrieves evaluation criteria based upon data in the transaction data set specifying at least one of an identity associated with the entity-specific processor circuit and data indicative of an electronic account to which the transaction data set applies. The retrieved evaluation criteria is used with data in the transaction data set to derive evaluation result data for the transaction data set, and the generated audit data and derived evaluation result data are provided for access by the entity-specific processor circuit that generated the transaction data set.

In connection with various embodiments, a plurality of entity-specific processor circuits, as discussed above and respectively operated on behalf of one of a plurality of disparate sponsoring entities, use the provided audit data and evaluation result data to generate and assign value data to an electronic account associated with the transaction data set. The account association is identified or otherwise determined using stored data maintained for each account, as associated with a generated transaction data set for which the audit and evaluation data is generated.

According to another example embodiment of the present invention, an auditing and evaluation system interacts with a multitude of institution-specific transaction processors to provide auditing, evaluation and/or other processing services. The system is configured to interact with each of the institution-specific transaction processors and their respective operating/processing systems. Each processor carries out transactional data processing, with auditing and evaluation carried out at the system.

In connection with various embodiments the auditing and evaluation system further provides financing for electronic transactions processed by the institution-specific transaction processors, which respectively authorize/facilitate payment in response to not only the auditing/evaluation data provided by the system, but also using funds provided via the system.

In some embodiments, the auditing and financing system processes and maintains data characterizing credit-based information such as those relating to payables, receivables, financed transactions and the respective entities on behalf of which credit has been extended and from which payment is expected. In this context, credit worthiness of one or more transaction parties and/or sponsoring parties (i.e., banks) is generally accessible.

In some embodiments, auditing involves determining that the transaction is payable, and classifying the transaction per an accounting-directed code based on the audit and a credit-worthiness assessment as discussed herein. For example, transactions may be classed (e.g., grouped) according to a credit-worthiness standard or score that may pertain to one or more of transaction participants, type of transaction, type of goods or services, and/or how the transaction relates to the participating entities. For example, where a transaction pertains to a buyer's core business (e.g., raw materials), a higher credit-worthiness assessment may be made relative, for example, to a transaction that does not pertain to core business (e.g., office equipment or research and development).

Other embodiments are directed to processing outputs for one or more of global-enterprise functions with accounting classification (e.g., classifying expenses), pool of credit-based extension of credit with related analysis and processing, receipting and auditing of business-to-business transactions, and multi-national commerce situations with enforcement of consistent rules for transactions originating in disparate systems located in different international areas. For instance, audit data may be tailored to specific currencies or regulatory rules pertinent to one or more countries in which a transaction entity is organized.

According to another example embodiment of the present invention, a computer-based transaction processing system audits and processes transaction data by interacting with a multitude of different processors (or processing systems), with each processor corresponding to a sponsoring bank and operating under that bank's operating conditions. Each bank-specific processor carries out transaction functions for buyers and sellers involved in electronic transactions executed via the processor, and a global processor communicates and interacts with each of the bank-specific processors. These communication and interaction functions are carried out using communications protocols, programming functions and other characteristics as appropriate, which are tailored or otherwise set for each specific bank. In this context, the global processor can interact with disparate bank systems operating on different types of hardware and using different software-based functionality, to globally process transactions involving the disparate systems and to monitor the same.

The global processor communicates with each bank-specific processor to receive transaction data for business-to-business transactions sponsored by the bank for which the bank-specific processor is operated. The global processor audits the transaction data according to business rules pertaining to a sponsoring bank involved in the transaction and, where appropriate, business rules pertaining to parties to the transaction such as buyers and/or sellers. The global processor also determines a credit-based characteristic as a function of at least one of the buyer, seller and the sponsoring bank-specific processor, and uses the credit-based characteristic and data from the audit to generate and communicate data to facilitate the financing of transactions sponsored by the bank-specific processor. This data is used to effect payment to the seller in each transaction, and further to collect settlement from the buyer.

In this context, each bank-specific processor carries out functions relating to each transaction pertaining to its client or clients (i.e., one or both of a buyer and seller involved in the transaction). Business-to-business data for each transaction is thus effectively maintained at the bank-specific processors, with the global processor carrying out auditing and financing functions for each bank-specific processor.

The global processor assesses a fee for financing transactions, which fee may be part of and/or in addition to any fee assessed by the bank-specific processor. Where appropriate, the fee may depend upon the length of time by which credit is extended, such as the time between any payment made to a seller via the global processor, and the receipt of settlement for such a payment either from the seller or from another entity such as the sponsoring bank.

In some embodiments, the global processor audits the transactions for each bank-specific processor and provides audit data back to the bank-specific processor to facilitate payment for the transaction. With this approach, transactions that are processed by disparate banks can be audited centrally according to rules that may, if appropriate, apply globally to different transactions and to different banks. This approach also allows each bank-specific processor to carry out transactions relatively independent from other bank-specific processors for its specific clients, and to maintain transaction data for its clients, while using central auditing functions.

In some implementations, the global processor audits transactions by executing central underwriting-based auditing functions to determine a credit-based condition for the transactions. The global processor provides that determined condition back to the bank-specific processors. In these instances, the determination of a credit-based condition may involve using global credit worthiness rules and/or rules that are specific to a particular bank processor. An electronic fee can be assessed, as part of and/or in addition to any fee assessed by the bank-specific processor for processing and financing the truncation for which the credit-based condition is determined.

In other implementations, the global processor carries out regulatory-based auditing functions for each bank-specific processor, to provide an independent assessment or audit of transactions processed at a bank-specific level. This approach is useful to facilitate transparency relative to one or more of a variety of transaction characteristics, such as to ensure proper accounting practices or to facilitate accurate evaluation of a particular entity's financial position or credit worthiness.

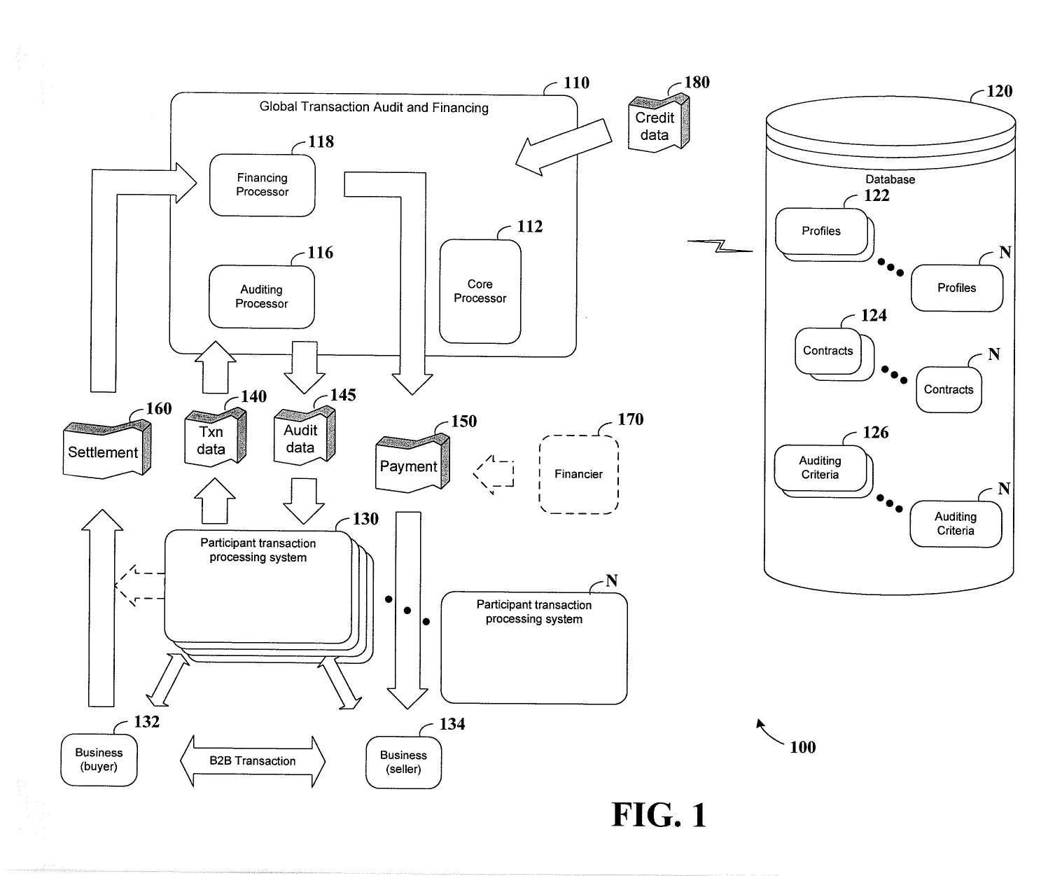

Turning now to the figures, FIG. 1 shows a system 100 for central, global interactive control of transactions processed by a multitude of disparate participating banking entities and their respective processors, according to another example embodiment of the present invention. The system 100 includes a global transaction audit and financing processing arrangement 110 that is programmed (e.g., with an algorithm) to audit and facilitate (e.g., underwrite) payment for transactions using party profiles and business/underwriting rules provided by transaction processing systems 130-N for participating banks. The global processing arrangement 110 operates in a manner similar to the global processors and related approaches described above, to interact with disparate transaction processing systems for each of the participating banks, and for providing payment 150 for each transaction.

Referencing participating bank-specific transaction processing system 130, each bank-specific system interacts with buyers (132) and sellers (134) directly to facilitate business-to-business transactions therebetween. This interaction may involve, for example, obtaining transaction information such as order, invoice and receipt information upon which a transaction and its payment can be based. For different embodiments, the bank-specific processor may or may not act upon (some or all of) the obtained transaction information, and may or may not pass (some or all of) the information from the bank-specific systems 130-N to the global processing arrangement 110, depending upon the particular transaction processing functions carried out at the respective processor locations. In addition, each bank-specific processor interacts with each of its buyer and/or seller clients to obtain information that is used to create a profile for each client, upon which transactions can be processed. Where appropriate, each bank-specific processor also stores business rules for each client of the bank specific to that processor. These business rules may be part of the client's profile information, and may include rules by which the client prefers transactions to be processed (e.g., approval, payment and financing information).

When transactions are to be processed, the transaction processing system 130 receives transaction information such as an invoice from the seller 134, and in response provides transaction data 140 to the global processing arrangement 110. The transaction data 140 includes information pertaining to the transaction, such as transaction party information (i.e., about buyers, sellers and financiers involved in the transaction), profile information for each transaction party, and payment information from the invoice.

The global processing arrangement 110 includes a core processor 112 that maintains interactions with each bank-specific participant transaction processing system, and also maintains a database 120 that includes information for transactions processed using the global processor. Different types of information can be maintained for different types of transactions, and further depending upon the type of interaction desired with the respective sponsoring banks. Shown by way of example, the database 120 includes profiles 122-N, contracts 124-N and auditing criteria 126-N that respectively pertain to one or more transaction participants (buyers, sellers and financiers).

The information from the database that is used by the core processor 112 is information pertinent to auditing and financing transactions and accordingly depends upon interactive characteristics between two or more of the following: the global processing arrangement 110, a bank-specific processor (130) and buyer/seller participants. In some instances, the core processor stores contract, profile and auditing information on behalf of a bank-specific processor in order to carry out auditing functions implementing all of this information. In other instances, the core processor stores a less comprehensive set of information that is sufficient to carry out auditing and financing functions. Further discussion of the use of profiles, contracts and auditing criteria as may be applicable for implementation here is made in other sections of this document.

The core processor 112 interacts with an auditing processor 116 that audits the transaction data 140 to determine conditions of each transaction upon which payment can be made. The core processor 112 also interacts with a financing processor 118 that uses information from the audits carried out by the auditing processor to finance transactions. Respectively, these processors carry out remote, global auditing/payment functions for a multitude of bank-specific transaction processors, based upon agreements and related processing functions (e.g., software blocks) to control interactive functionality between the global processing arrangement 110 and each participant transaction processing system 130.

When the auditing processor 116 audits a transaction that is payable, the financing processor 118 determines a financial condition pertaining to payment using, for example, a credit-based characteristic of one or more transaction participants including buyers, sellers and financial institutions. If payment is appropriate for a particular transaction, the financing processor 118 sends payment 150 to a seller 134, and collects settlement 160 on behalf of a buyer 132.

While FIG. 1 shows payment and settlement directly between the financing processor and the buyer and seller (132 and 134) in the transaction, other indirect electronic payment and settlement approaches are used for different embodiments. For instance, payment may be made by a financier participant 170 that sends the payment 150 to the seller 134, and which further contracts with the global processing arrangement 110 for effecting payment and obtaining an interactive-based fee for making the payment. Similarly, settlement may be provided by the bank-sponsored processor 130, using funds from or otherwise pertaining to the buyer 132.

Each of the core, auditing and financing processors 112, 116 and 118 can be implemented in a variety of manners. For instance, each indicated processor or manager can be effected by software functions/modules operating on a computer system, which may be common to all processors. Separate computers or computer systems may implement aspects of one or more processors. Each processor uses data that corresponds to transaction characteristics (e.g., pricing and other information from an invoice), data that corresponds to rules for auditing the transaction, and programming functions for processing the data together to automatically audit the transaction. Moreover, the functions described as corresponding to a particular processor may be carried out on a common processor and/or in a mixed fashion. For instance, the auditing and financing processors 116 and 118 may be combined, such that a result generated corresponds to both auditing and financing functions, such as where a positive audit also includes a financing approval.

The system 100 processes a variety of transactions, including those for goods or services between buyers and sellers, transactions between financial institutions, transactions between buyers or sellers and one or more of the financial institutions, and transactions involving other entities such as intermediary sellers or distributors. In each instance and for each participating bank-specific transaction processing system (130-N), the global processing arrangement 110 oversees auditing and financing aspects of each transaction, with buyer and seller participants interacting directly with the participating bank-specific system. In many applications, the buyer and seller may be unaware of any interaction by the global processing arrangement 110, with payment 150 and settlement 160 occurring via the bank-specific processor 130 or otherwise.

In some instances, an external credit rating is provided at 180 and used by the financing processor 118 to determine a condition upon which financing can be extended to a buyer. The credit rating 180 may pertain to one or more of a buyer, seller or sponsoring financial institution involved in a particular transaction. Such ratings may be used in auditing and underwriting payment for transactions. These credit ratings may also be used in assessing the portfolio risk for a particular financier, by assessing the credit ratings of parties in debt to a financier or sponsoring bank, and/or for which the financier holds receivables. Such a portfolio risk assessment may be used in determining whether to extend credit in instances where a particular financier is involved in the process of providing settlement 160, either directly or by providing the funds as received from a client buyer.

The global processing arrangement 110 facilitates payment via the extension of credit using approaches, depending upon the application. For instance, in some applications, payment is made to a seller on behalf of a buyer for payables financing. In other applications, payment is made on behalf of a seller for receivables financing. Collection (for payments made) is from a buyer in either instance, or from a buyer financial institution that has assumed the buyer's debt. For payables financing, business rules of the buyer are applied in making a decision to pay, relative to an audit or other approach, and the business rules from the seller may also be applied where appropriate given related rules and/or contract data. For receivables financing, business rules of the seller are applied to make a decision to pay, relative to an audit or other approach, and business rules from the buyer are correspondingly also applied for certain applications. In each of these instances, a bank (e.g., for processor 130) sponsoring the transactions can also be involved in the extension of credit, either as the creditor or debtor.

In some embodiments, the financing processor 118 uses profiles 122 to select a payment funding source according to a credit rating for an owing party in a transaction. For example, the owing party's profile or related business rules may specify different funding sources based upon the party's current credit rating, or based upon rates associated with the credit rating. An owed party's profile or related business rules may also specify different funding terms (e.g., interest rate, credit limits) based upon updated business rules or profiles corresponding to a credit rating for an owing party on behalf of which credit is extended. In this context, the financing processor uses credit terms and sources as appropriate based upon changing conditions relating to credit or other conditions. This is carried out globally across different bank-specific systems.

In some embodiments, certain profiles for one or more particular transaction parties such as buyers, sellers or financiers are managed by the system to provide a third-party overview of a transaction party's historical and current credit-based status, or of a status of a pool of credit held by one or more financiers. The nature of the global processing arrangement 110 is useful for observing a multitude of different banking entities and their respective transactions, with insight provided on a controlled basis for transactions audited and processed therefore. For instance, where a financier extends credit on behalf of a buyer, historical data is used to characterize that extension of credit and its effect upon the financiers' portfolio risk. Collectively applied across receivables for a particular financier (i.e., across individuals or entities in debt to financier), this approach is useful for providing an indication of the financier's ability to collect upon its receivables based upon historical and related information for each entity to which the financier has extended credit.

As specifically relevant to credit pools from which credit is extended to different entities for effective payment, the global processing arrangement 110 includes a credit pool processor circuit that provides pooled credit funds to the different entities. The credit pool processor maintains data sets representing a plurality of electronic pools of credit, each electronic pool of credit having transaction-type term characteristics for the pool, available funds data and, for each entity on behalf of which credit from the pool has been extended, entity ID data and an amount that the entity owes to the pool of credit. For respective transactions, the credit pool processor selects a pool of credit from which to provide funds to cover electronic payment, using derived credit data, data for the transaction and term characteristics of the pool of credit. This may involve, for example, assessing a credit-worthiness of a particular transaction data set as discussed herein, and matching that assessed credit-worthiness to a credit worthiness assigned to a credit pool. The credit pool processor also directs funds to effect settlement to the pool of credit (e.g., upon receipt of a payment for a transaction or group of transactions), and where appropriate, assesses fees via the fee assessment engine as a function of funds provided from the pool of credit.

Various embodiments described herein are applicable for use with a variety of transaction processing approaches. For instance, certain embodiments involve using auditing and payment processing with a system and approach such as that disclosed in U.S. patent application Ser. No. 11/151,747 (by Hahn-Carlson) entitled “Financial Institution-based Transaction Processing System and Approach” and filed Jun. 9, 2005. Other embodiments involve using auditing and/or payment with a system and approach as disclosed in U.S. Pat. No. 5,910,896 (also by Hahn-Carlson). Moreover, various example embodiments of the present invention are also implemented with a variety of payment processes involving, for example, credit-based payment, corporate payment credit cards, business-to-business transactions, bank-to-bank transactions, as well as related software and other processing functions carried out in connection with the same. In this context, the following discussion of the figures and the information shown therein may also be applied on connection with these patent documents.

In another example embodiment of the present invention, the global processing arrangement 110 uses business rules (e.g., included in profile information) associated with financial institutions to directly process financial transactions between parties sponsored by the financial institutions. When the global processing arrangement 110 receives transaction information, the information is parsed for identifying characteristics that can be associated with sponsoring financial institutions. When these identifying characteristics match a particular financial institution, the global processing arrangement 110 uses business rules for the financial institution to process the financial transaction. In addition, when identifying characteristics for different parties to the transaction match different financial institutions, financial aspects of the transaction that are specific to each party are processed according to the each party's corresponding sponsoring financial institution. Funds relating to the financial transaction are thus transferred according to the business rules associated with the sponsoring financial institutions for each party and to the particular characteristics of the financial transaction. Such an approach may involve, for example, one or more aspects as discussed in U.S. patent application Ser. No. 11/151,747, filed on Jun. 9, 2005 and fully incorporated herein by reference.

In a more particular example embodiment of the present invention, the global processing arrangement 110 uses rules to automatically classify accounting data for parties to a transaction, the rules being defined as a function of the parties and/or the transaction. Accounting information is associated with a particular set of rules and processed in accordance with the rules. In some instances, the processing involves assigning accounting codes to the accounting information. In other instances, accounting codes are assigned as a function of a transaction party for which the accounting information is being processed. Such an approach may involve, for example, one or more aspects as discussed in U.S. patent application Ser. No. 11/121,158, filed on May 3, 2005 to Hahn-Carlson (now U.S. Pat. No. 7,392,934), and fully incorporated herein by reference.

In another example embodiment, the global processing arrangement 110 is implemented as follows in the context of performing an adaptive audit (i.e., with auditing processor 116) that bases the audit upon rules and auditing characteristics that are adapted using conditions relating to one or more transaction parties. Business rules and profiles are stored and accessed for facilitating the transactions, the business rules and the profiles being part of a data set and at least a part of the data set being accessible by parties from respective locations that are remote from the system. The global processing arrangement 110 is programmed for auditing and facilitating payment for initial ones of the transactions as a function of the business rules and the profiles of parties involved in the initial transactions. For one of the parties involved in a plurality of the transactions occurring over time, the global processing arrangement 110 develops a historical record of selected aspects of the transactions and tracks attributes indicative of a credit rating for said one of the parties. The global processing arrangement 110 also adaptively develops, in response to the historical record of selected aspects and the tracked attributes, updated business rules and profiles pertaining to said one of the parties, and uses the updated business rules for auditing and facilitating payment for ongoing transactions. Such an approach may involve, for example, one or more aspects as discussed in U.S. patent application Ser. No. 12/506,956 filed on Jul. 21, 2009, and fully incorporated herein by reference.

In some embodiments, the system 100 operates as follows. The participant bank-specific transaction processing systems 130-N are disparate bank-specific software-programmed computer processors that respectively provide electronic transaction data processing functions for bank clients including at least one of a buyer and seller (e.g., 132 and 134) involved in each sponsored transaction. Each bank-specific processor 130-N operates to, for each of its buyer and/or seller clients, store electronic payment account data, post debits and credits to the payment account, and receive transaction data (e.g., orders, invoices) for transactions involving the buyer and/or seller.

The global processing arrangement 110 is a computer processor circuit (e.g., a software-programmed processor) that electronically communicates with all of the bank-specific processors 130-N, and audits transaction data provided by the bank-specific processor for business-to-business transactions sponsored by the bank for which the bank-specific processor is operated. The global processing arrangement provides data corresponding to the audit, and further derives credit data representing a credit-based characteristic related to the transaction using data assigned to at least one of the buyer, seller and the sponsoring bank. The global processing arrangement 110 also finances transactions sponsored by the bank-specific processors using the audit data and credit data, by providing electronic payment for the seller in each transaction and collecting electronic settlement made on behalf of the buyer.

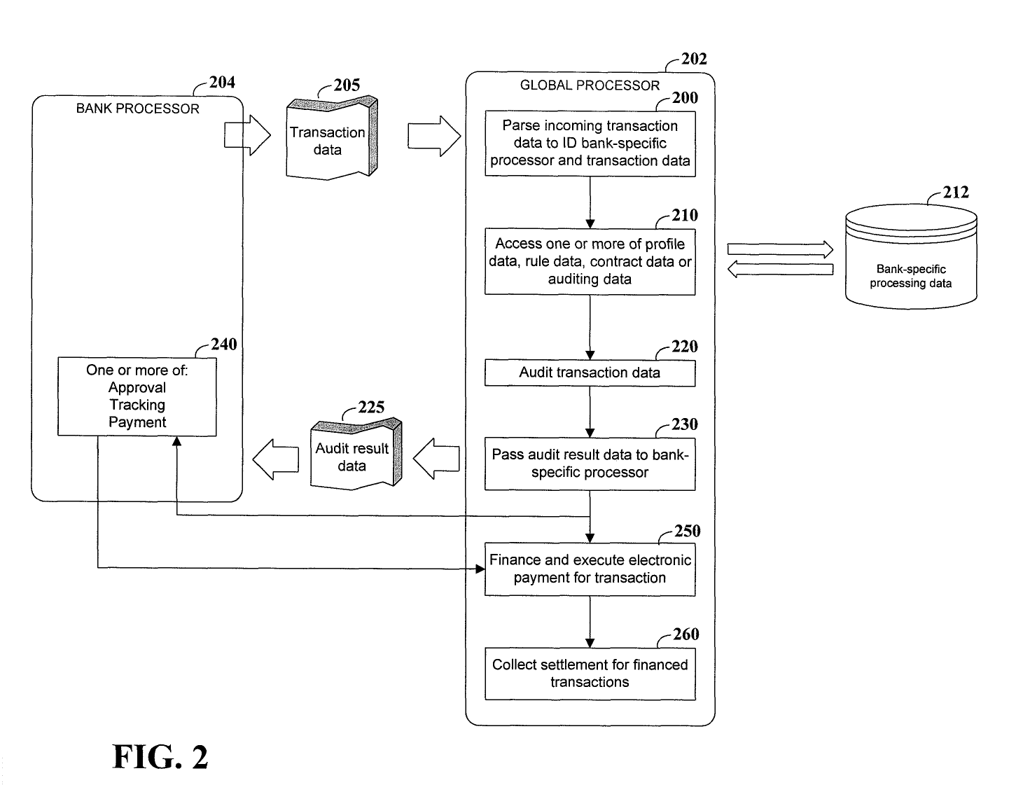

FIG. 2 shows a flow diagram for transaction processing, according to another example embodiment of the present invention. The approach shown in FIG. 2 may be implemented in a system such as that shown in FIG. 1 (e.g., as part of an algorithm), and is applicable to a variety of example embodiments.

At block 200, a global processor 202 parses incoming transaction data from a bank-specific processor 204 to identify the bank-specific processor and related characteristics by which auditing and financing can be carried out. Such identification and validation may involve, for example, identifying the document as pertaining to a particular transaction and validating the document according to one or more of source, content and authentication information. Profiles and corresponding business rules, contracts or auditing criteria relating to the identified transaction, as may be relevant to a particular transaction party (e.g., buyer, seller or sponsoring bank), are accessed at bock 210 for use in auditing the transaction data and, where appropriate, determining financing characteristics for the transaction. Bank-specific processing data 212, which may include data such as profiles, business rules and processor-specific communications protocols, may be stored on behalf of one or more banks and accessed at block 210. Corresponding audit data is generated at block 210, and presented for use in determining a condition of payment authorization for the transaction data, such as by automatically determining a condition for buyer payment approval or for credit approval. In some instances, the audit data is passed to a bank-specific processor for use in carrying out transaction functions, which may involve providing payment and/or collecting settlement for a transaction.

At block 220, the transaction data is audited and audit result data is used to determine whether a transaction is in condition for payment. In some instances, audit result data 225 is passed to the bank-specific processor 204 at block 230, which uses the result data for transaction processing functions including one or more of approval, tracking or payment at block 240. In such instances, the global processor 202 acts to centrally carry out audit and/or approval functions for remote bank processors, and returns data to the bank processors for use in effecting payment. The respective bank-specific processors are thus provided with processing functions specific to the global processor 202, which has access to data and processing functions that may not otherwise be accessible to the bank-specific processors, from one or both of a security/authorization and compatibility perspective (e.g., disparate systems may be incompatible with one another and/or not permit access by remote non-party systems). From a technical perspective and in connection with certain embodiments, the resulting functions at each bank-specific processor are thus provided with an audit data set that may otherwise be unavailable or impossible to generate due to the lack of access to underlying data, or due to such underlying data being incompatible.

For some embodiments, the audit result data is used at block 250, together with additional financing data as appropriate, to finance and pay transactions. For example, the audit data may include data that, when executed with an algorithm together with transaction-specific data, indicates a condition of buyer-based payment authorization and/or financier-based credit approval. Settlement is then collected at block 260, either directly from a participating owing party (i.e., from a buyer), from a sponsoring bank or from another entity providing payment on behalf of the owing party.

The various embodiments as discussed herein may be implemented using a variety of structures and related operations/functions. For instance, one or more embodiments as described herein may be computer-implemented or computer-assisted, as by being coded as software within a coding system as memory-based codes or instructions executed by a computer processor, microprocessor, PC or mainframe computer. Such computer-based implementations are implemented using one or more programmable or programmed circuits that include at least one computer-processor and internal/external memory and/or registers for data retention and access. One or more embodiments may also be implemented in various other forms of hardware such as a state machine, programmed into a circuit such as a field-programmable gate array, implemented using electronic circuits such as digital or analog circuits. In addition, various embodiments may be implemented using a tangible storage medium that stores instructions that, when executed by a processor, performs one or more of the steps, methods or processes described herein. These applications and embodiments may also be used in combination; for instance certain functions can be implemented using discrete logic (e.g., a digital circuit) that generates an output that is provided as an input to a processor.

While certain aspects of the present invention have been described with reference to several particular example embodiments, those skilled in the art will recognize that many changes may be made thereto. For example, it is within the spirit and scope to implement a program or code that can be stored in a machine-readable medium to permit a computer to perform one or more aspects of the approaches described above as well as in the claims that follow. These changes may be made without departing from the spirit and scope of the present invention, aspects of which are set forth in the following claims.

What is claimed is:

1. A system for auditing and evaluating transaction data sets, the system comprising:
a plurality of entity-specific processor circuits respectively operated on behalf of one of a plurality of disparate sponsoring entities, each processor circuit configured to
store data identifying each of a plurality of electronic accounts,
for received transaction data, generate a transaction data set indicative of the received transaction data and associated with the data identifying one of the electronic accounts, and
for each of the electronically-identified accounts, generate and assign value data to the account in response to received audit and evaluation result data for transaction data sets associated with the account; and
a service processor circuit configured to, for each transaction data set received from an entity-specific processor,
associate the transaction data set with the entity-specific processor
based upon the association, retrieve auditing rules defined for the entity-specific processor,
access and execute an auditing algorithm as a function of the retrieved auditing rules, using data in the transaction data set as an input to the algorithm, therein generating audit data for the transaction data set,
retrieve evaluation criteria based upon data in the transaction data set specifying at least one of an identity associated with the entity-specific processor circuit and data indicative of an electronic account to which the transaction data set applies,
use the retrieved evaluation criteria with data in the transaction data set to derive evaluation result data for the transaction data set, and
provide the generated audit data and derived evaluation result data for access by the entity-specific processor circuit that generated the transaction data set.

2. A computer-based system for auditing and processing transaction data for business-to-business transactions, the system comprising:
a plurality of bank-specific processor circuits respectively operated on behalf of one of a plurality of disparate sponsoring banks, each processor circuit configured, for each of a multitude of bank clients including at least one of a buyer and seller involved in each transaction sponsored by the bank for which the processor circuit is operated, to
store data for an electronic payment account for the client,
post at least one of a debit and a credit to the payment account, and
receive transaction data for transactions involving the client; and
a global processor circuit configured to electronically communicate with the bank-specific processor circuits to receive transaction data sets provided by the bank-specific processor circuits, and configured to, for each bank-specific processor circuit and a sponsoring bank associated therewith, audit transaction data sets provided by the bank-specific processor circuit, therein generating audit data for each transaction data set, and for each audited transaction data set and a corresponding transaction, to
derive credit data representing a credit-based characteristic related to the audited transaction data set using data assigned to at least one of the buyer, seller and the sponsoring bank, and
generate an electronic payment instruction for the seller and collect electronic settlement made on behalf of the buyer, based upon the audit data and credit data.

3. The system of claim 2, wherein the global processor circuit is configured to electronically communicate with each of the bank-specific processor circuits for accessing data including at least one of the stored data, posted payment account and received transaction data, and audits the transaction data sets using the accessed data.

4. The system of claim 2, wherein the global processor circuit is configured to generate an electronic payment instruction for the seller and collect electronic settlement made on behalf of the buyer by communicating electronic payment data to the bank-specific processor circuit involved in the transaction to instruct the bank-specific processor circuit to provide payment to the seller and to collect settlement from the buyer.

5. The system of claim 2, wherein the global processor circuit is configured to
store data pertaining to credit extended to make electronic payment on behalf of at least one of the buyer, seller and sponsoring bank for the transaction, and
provide the stored data for use in determining creditworthiness of at least one of the buyer, seller and sponsoring bank.

6. The system of claim 2, wherein the global processor circuit is configured to audit transaction data sets by
processing transaction-specific data sets with stored rules for at least one of a buyer, seller and sponsoring bank to determine that the transaction to which the data applies is payable, and
classifying the transaction data by configuring the data with an accounting-directed code based on the determination that the transaction is payable.

7. The system of claim 2, wherein the global processor circuit is configured to
store data representing credit extended for electronic payments made on behalf of at least one of the buyer, seller and sponsoring bank for each transaction, and use the stored data to determine creditworthiness data for at least one of the buyer, seller and sponsoring bank,
audit transaction data sets by using rules for at least one of the buyer, seller and sponsoring bank for the transaction to determine that the transaction is payable, and
classify the transaction data by configuring the data with an accounting-directed code based on the determination that the transaction is payable and the determined creditworthiness data.

8. The system of claim 2, wherein the global processor circuit is configured to generate fee data to assess a fee for electronic payments provided in accordance with one or more of an amount of the electronic payment, a credit term associated with the payment, underwriting for the payment, and the auditing functions carried out in relation to the payment.

9. The system of claim 2, wherein the global processor circuit is configured to audit the transaction data sets by executing an algorithm with auditing rules data that are globally applied to at least two different sponsoring banks.

10. The system of claim 2, wherein the global processor circuit is configured to audit the transaction data sets by executing an algorithm with auditing rules data associated with at least one of a buyer, a seller and a sponsoring bank involved in the transaction to which the transaction data set applies.

11. The system of claim 2, wherein
the global processor circuit is configured to transmit the generated audit data to one of the bank-specific processor circuits to which the transaction data set applies, and
the one of the bank-specific processor circuits is configured to generate transaction authorization data in response to the audit data.

12. The system of claim 2, wherein
the global processor circuit is configured to audit the transaction data sets to generate the audit data using financial data for at least one of a buyer and a seller for the transaction to determine a condition of credit extension for the transaction, and to transmit the generated audit data to the bank-specific processor circuit for a sponsoring bank involved in the transaction, and
the bank-specific processor circuit for the sponsoring bank is configured to
audit the transaction data set based upon data identifying account characteristics for the at least one of a buyer and seller involved in the transaction, therein generating bank-specific audit data, and
generate transaction authorization data in response to the audit data received from the global processor circuit and the bank-specific audit.

13. The system of claim 2, wherein the global processor circuit includes a credit pool processor circuit for providing pooled credit funds to different entities, the credit pool processor circuit being configured to
maintain data sets representing a plurality of electronic pools of credit, each electronic pool of credit having transaction-type term characteristics for the pool, available funds data and, for each entity on behalf of which credit from the pool has been extended, entity ID data and an amount that the entity owes to the pool of credit,
select a pool of credit and provide funds therefrom for providing the electronic payment, using the derived credit data, the transaction data and term characteristics of the pool of credit, and
interact with the transaction processor to direct funds provided via the payment processor, to direct funds to effect settlement to the pool of credit, and to assess a fee via the fee assessment engine as a function of funds provided via the pool of credit.

14. The system of claim 2, wherein the global processor circuit is configured to
audit multi-national transactions involving a buyer and a seller having sponsoring banks respectively located in different countries, and
generate the audit data for approving transactions on behalf of each of the sponsoring banks, based upon at least one country-specific auditing criteria.

15. The system of claim 2, wherein the global processor circuit is configured to generate an electronic payment instruction for the seller and collect electronic settlement made on behalf of the buyer, based upon the audit data and credit data, by
using buyer-specific audit data to determine a condition of payment authorization on behalf of the buyer, and
in response to the determined condition of payment authorization, using the derived credit data to determine whether to issue credit on behalf of the specific buyer for the electronic payment.

16. The system of claim 2, wherein the global processor circuit is configured to
electronically communicate with the bank-specific processor circuits using communications protocols specific to the bank-specific processor circuits, and
generate and send the electronic payment instruction to the bank-specific processor circuit, using the communications protocols specific to the bank-specific processor circuits.

17. A method for auditing and processing transaction data for business-to-business transactions, the method comprising:
in each of a plurality of bank-specific processor circuits respectively operated on behalf of one of a plurality of disparate sponsoring banks, for each of a multitude of bank clients including at least one of a buyer and seller involved in each transaction sponsored by the bank for which the processor circuit is operated,
storing data for an electronic payment account for the client,
posting at least one of a debit and a credit to the payment account, and
receiving transaction data for transactions involving the client; and
in a global processor circuit,
electronically communicating with each of the bank-specific processor circuits to receive transaction data sets provided by the bank-specific processor circuits, and
for each bank-specific processor circuit and a sponsoring bank associated therewith, auditing transaction data sets received from the bank-specific processor circuit and therein generating audit data, and for each audited transaction data set and a corresponding transaction,
deriving credit data representing a credit-based characteristic related to the audited transaction data set using data assigned to at least one of the buyer, seller and the sponsoring bank, and
generating an electronic payment instruction for the seller and collecting electronic settlement made on behalf of the buyer, based upon the audit data and credit data.

18. The method of claim 17, wherein electronically communicating with each of the bank-specific processor circuits includes, in the global processor circuit, communicating with each of the bank-specific processor circuits for accessing data including at least one of the stored data, posted payment account and received transaction data, and auditing the transaction data sets using the accessed data.

19. The method of claim 17, wherein generating an electronic payment instruction for the seller and collecting electronic settlement made on behalf of the buyer includes communicating electronic payment data to the bank-specific processor circuit involved in the transaction to instruct the bank-specific processor circuit to provide payment to the seller and to collect settlement from the buyer.

20. The method of claim 17, further including, in the global processor circuit,
storing data pertaining to credit extended to make electronic payment on behalf of at least one of the buyer, seller and sponsoring bank for the transaction, and
providing the stored data for use in determining creditworthiness of at least one of the buyer, seller and sponsoring bank.

21. The method of claim 17, wherein auditing transaction data sets includes executing an algorithm with auditing rules data associated with at least one of a buyer, a seller and a sponsoring bank involved in the transaction to which the transaction data set applies.

22. The method of claim 17, wherein generating an electronic payment instruction includes
using buyer-specific audit data to determine a condition of payment authorization on behalf of the buyer, and
in response to the determined condition of payment authorization, issuing credit on behalf of the specific buyer for the electronic payment using the derived credit data to determine whether to issue credit on behalf of the specific buyer for the electronic payment.

23. The method of claim 17, wherein
electronically communicating with each of the bank-specific processor circuits includes using communications protocols specific to each bank-specific processor circuit, and
generating an electronic payment instruction includes generating and sending an electronic payment instruction to the bank-specific processor circuit, using the communications protocols specific to the bank-specific processor circuit.
